(19) United States
(12) Patent Application Publication
(10) Pub. No.: US 2010/0167676 A1
(43) Pub. Date: Jul. 1, 2010

(54) FILTERING APPARATUS AND METHOD USING REFERENCE FEEDBACK CIRCUIT OF WIRELESS COMMUNICATION SYSTEM

(75) Inventors: Hangue PARK, Seoul (KR); WonSuk Choi, Seongnam-si (KR); JongWook Zeong, Seoul (KR)

Correspondence Address: THE FARRELL LAW FIRM, LLP, 290 Broadhollow Road, Suite 210E, Melville, NY, 11747, US

(73) Assignee: Samsung Electronics Co., Ltd.

(21) Appl. No.: 12/648,921

(22) Filed: Dec. 29, 2009

(30) Foreign Application Priority Data
Dec. 30, 2008 (KR) 10-2008-0136434

(51) Int. Cl. H04B 17/00; H04B 1/10

(52) U.S. Cl. 455/226.2; 455/307

(57) ABSTRACT

A filtering apparatus and method using a reference feedback circuit is disclosed. The filtering apparatus includes an input signal generating unit, a reference feedback unit, and a band-pass filter. The input signal generating unit generates an input signal in an allocated band that the receiver uses. The reference feedback unit compares the power of the input signal with that of an output signal and generates a reference signal. The output signal is generated as a band-pass filter filters the input signal with respect to the allocated band. The band-pass filter adjusts the quality factor (Q factor) of a receiver according to the reference signal and passes frequencies of the input signal input to the receiver only within the allocated band.

### PRIORITY

This application claims priority to an application entitled “FILTERING APPARATUS AND METHOD USING REFERENCE FEEDBACK CIRCUIT OF WIRELESS COMMUNICATION SYSTEM” filed in the Korean Intellectual Property Office on Dec. 30, 2008 and assigned Serial No. 10-2008-0136434, the contents of which are incorporated herein by reference.

### BACKGROUND OF THE INVENTION

1. Field of the Invention

The present invention relates to wireless communication systems, and more particularly, to a filtering apparatus and method that enhances the characteristics of a filter in a receiver of a wireless communication system, using a reference feedback circuit.

2. Description of the Related Art

In a transmitter used for baseband communication, a low-pass filter can remove interference except for the original signal. However, in most communications, radio frequency carriers are used to prevent interference between communication channels. RF receivers used in RF systems must allow for particular frequency bands allocated to themselves, respectively. To this end, they must employ an RF band-pass filter.

In recent frequency allocation systems where frequency bands without guard frequency bands are used entirely for different purposes, if the digital circuit of the receiver does not employ an RF band-pass filter with a high quality factor (high Q factor), its front end or analog-digital converter (ADC) increases the overload due to signals of other frequency bands. That is, the digital units behind a band-pass filter of the receiver end increase the amount of work at the start end or at the ADC. In an environment where most RF receivers are manufactured through a Complimentary Metal Oxide Semiconductor (CMOS) process, most RF band-pass filters having a high Q factor are implemented with a ‘SAW filter’. However, since the SAW filter employs mechanical resonance, its volume is relatively large, and this makes it impossible for the filter to be formed as an Integrated Circuit (IC). Therefore, the RF receiver increases its manufacturing costs.

### SUMMARY OF THE INVENTION

The present invention has been made in view of the above problems, and provides a filtering apparatus and method that can enhance a quality factor (Q factor) of a filter, using a reference feedback circuit of a wireless communication system.

The present invention further provides a filtering apparatus and method that can compare the power of signals input to and output from a filter of a receiver and can control the filter, using a reference feedback circuit of a wireless communication system.

The present invention further provides a filtering apparatus and method that can remove interference from signals input to a filter of a receiver and can control the filter more precisely, using a reference feedback circuit of a wireless communication system.

In accordance with an embodiment of the present invention, a filtering apparatus using a reference feedback circuit of a receiver in a wireless communication system is provided. The filtering apparatus includes an input signal generating unit for generating an input signal in an allocated band that the receiver uses; a reference feedback unit for comparing the power of the input signal with that of an output signal generated as a band-pass filter filters the input signal with respect to the allocated band, and for generating a reference signal; and a band-pass filter for adjusting the quality factor (Q factor) of a receiver according to the reference signal and for passing frequencies of the input signal input to the receiver only within the allocated band.

Preferably, the reference feedback unit includes an input signal power measuring unit for measuring the power of the input signal; an output signal power measuring unit for measuring the power of the output signal generated as the band-pass filter filters the input signal within the allocated band; a comparator for comparing the power of the input signal with that of the output signal and generating a reference signal; and a controller for outputting a control signal according to the reference signal, where the control signal adjusts the quality factor (Q factor) of the band-pass filter.

The reference feedback unit may also includes: a reference filter for filtering the input signal within an allocated band; an input signal measuring unit for measuring the power of the input signal input to the reference filter; an output signal measuring unit for measuring the power of the output signal from the reference filter; a comparator for comparing the power of the input signal with that of the output signal and for generating a reference signal; and a controller for outputting a control signal according to the reference signal, where the control signal adjusts the quality factor (Q factor) of the reference filter and the band-pass filter.

In accordance with another embodiment of the present invention, a filtering method using a reference feedback circuit of a receiver in a wireless communication system is provided. The filtering method includes generating an input signal in an allocated band that the receiver uses; comparing the power of the input signal with that of an output signal generated as a band-pass filter filters the input signal with respect to the allocated band, and generating a reference signal; and adjusting the quality factor (Q factor) of a receiver according to the reference signal and for passing frequencies of the input signal input to the receiver only within the allocated band.

Preferably, generating a reference signal includes measuring the power of the input signal; measuring the power of the output signal generated as the band-pass filter filters the input signal within the allocated band; comparing the power of the input signal with that of the output signal, and generating a reference signal; and outputting a control signal according to the reference signal, where the control signal adjusts the quality factor (Q factor).

Preferably, generating a reference signal may also include measuring the power of the input signal; filtering the input signal within an allocated band; measuring the power of the filtered input signal; comparing the power of the input signal with that of the filtered input signal, and generating a reference signal; and outputting a control signal according to the reference signal, where the control signal adjusts the quality factor (Q factor).

### BRIEF DESCRIPTION OF THE DRAWINGS

The features and advantages of the present invention will become more apparent from the following detailed description in conjunction with the accompanying drawings, in which:

FIG. 1 illustrates a band-pass filter circuit according to an embodiment of present invention;

FIG. 2 illustrates a view describing a transfer function of a band-pass filter according to the magnitude of the negative resistance, according to an embodiment of the present invention;

FIG. 3 illustrates a view describing a band-limited input according to an embodiment of the present invention;

FIG. 4 illustrates a flow chart that describes a filtering method of a receiver according to an embodiment of the present invention;

FIG. 5 illustrates a block diagram that describes a filtering apparatus of a receiver according to an embodiment of the present invention;

FIG. 6 illustrates a block diagram illustrating a filtering apparatus according to an embodiment of the present invention; and

FIG. 7 illustrates a block diagram illustrating a filtering apparatus according to another embodiment of the present invention.

### DETAILED DESCRIPTION OF EMBODIMENTS OF THE PRESENT INVENTION

Hereinafter, exemplary embodiments of the present invention are described in detail with reference to the accompanying drawings. The same reference numbers are used throughout the drawings to refer to the same or similar parts. Detailed descriptions of well-known functions and structures incorporated herein may be omitted to avoid obscuring the subject matter of the present invention.

In an embodiment of the present invention, the wireless communication system transmits signals via radio frequency (RF) through the air. An RF receiver used in an RF system must allow for a particular frequency band allocated to itself. The system band allocated to the particular system is called a receiver-allocated band. In order to receive a band-limited input, the RF receiver must be implemented with an RF band-pass filter.

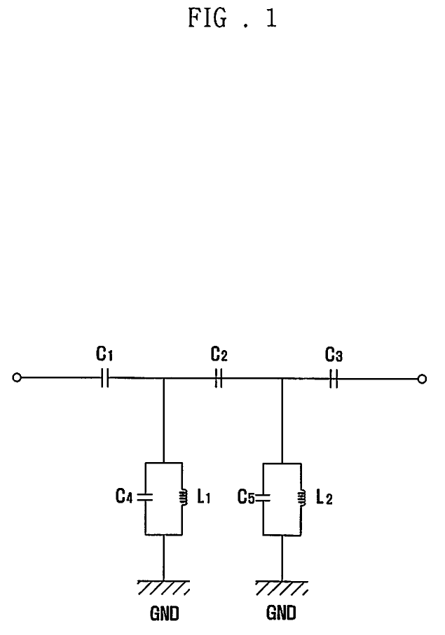

In the following description, an RF band-pass filter (hereinafter referred to as a ‘band-pass filter’) is explained with reference to FIG. 1. FIG. 1 shows a band-pass filter circuit according to an embodiment of the present invention.

Referring to FIG. 1, the band-pass filter includes first to fifth capacitors C1 to C5, and first and second inductors L1 and L2.

The first to third capacitors C1 to C3 are connected in series, where the second capacitor C2 serves as a coupling capacitor. The node between the first and second capacitors C1 and C2 is connected to the ground GND, through the fourth capacitor C4 and the first inductor L1 that are connected in parallel. Similarly, the node between the second and third capacitors C2 and C3 is connected to the ground GND, through the fifth capacitor C5 and the second inductor L2 that are connected in parallel.

In order to enhance the characteristics of the band-pass filter, it is preferable that the parallel circuit of the fourth capacitor C4 and first inductor L1 and the parallel circuit of the fifth capacitor C5 and second inductor L2 may be open with respect to the serial circuit of the first to third capacitors C1 to C3.

The first and second inductors L1 and L2 have a spiral structure, respectively. The first and second inductors L1 and L2 each have a component of parasitic resistance R. The quality factor Q of each of the inductors L1 and L2 can be expressed by the following Equation (1), considering parasitic resistance R.

$$Q = \frac{ω L}{R} \qquad ( 1 )$$

Wherein ω=2#f, f is frequency, R denotes parasitic resistance connected to an inductor in series or parallel and ω denotes the operating frequency of the filter, and is generally denotes a frequency component of impedance of the inductance. If the parasitic resistance increases, the quality factor Q decreases, which causes a filter Q limit. The filter Q limit causes an essential limitation when a band is established in a several GHz frequency range.

Therefore, in order to increase the Q factor, i.e., to acquire a high Q factor, inductance L needs to be increased but parasitic resistance R must be reduced. In an embodiment of the present invention, negative resistance −R is introduced to reduce the parasitic resistance R. That is, an active device generates negative resistance −R, so that the generated negative resistance −R can offset the parasitic resistance of the inductance L, thereby implementing a high Q factor.

When the parasitic resistance has been completely offset using the negative resistance −R, the filter serves as an oscillator due to the feedback of the active device, but this causes oscillation of the frequency response. In that case, the filter can be no longer used. Although oscillation does not occur, the frequency response is not flat but has serious ripples.

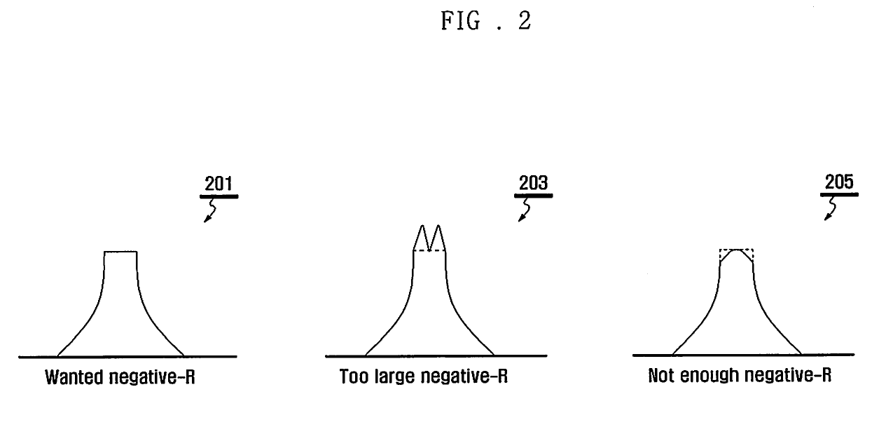

FIG. 2 is a view describing a transfer function of a band-pass filter according to the magnitude of the negative resistance, according to an embodiment of the present invention.

Referring to FIG. 2, in order to perform a filtering process with a high Q factor according to the negative resistance −R, the band-pass filter needs to offset the parasitic resistance R so the stability of the filter is not deteriorated. That is, the transfer function of an ideal filtering apparatus has a response as shown in waveform 201 in FIG. 2. However, if negative resistance −R is too large or small, the band-pass filter cannot sufficiently perform its function, as shown in waveforms 203 and 205 in FIG. 2, respectively.

The negative resistance −R value may be flexibly varied according to various CMOS manufacturing processes and various power supplies. In an embodiment of the present invention, a reference feedback circuit is introduced to adjust the negative resistance −R value so that the filtering apparatus can be stably operated.

The reference feedback circuit measures the power of signals input to and output from a band-pass filter and adjusts the negative resistance −R to compensate a Q factor according to the measured power.

In an embodiment of the present invention, interference is removed from a signal that will be input to the band-pass filter, thereby generating a band-limited input.

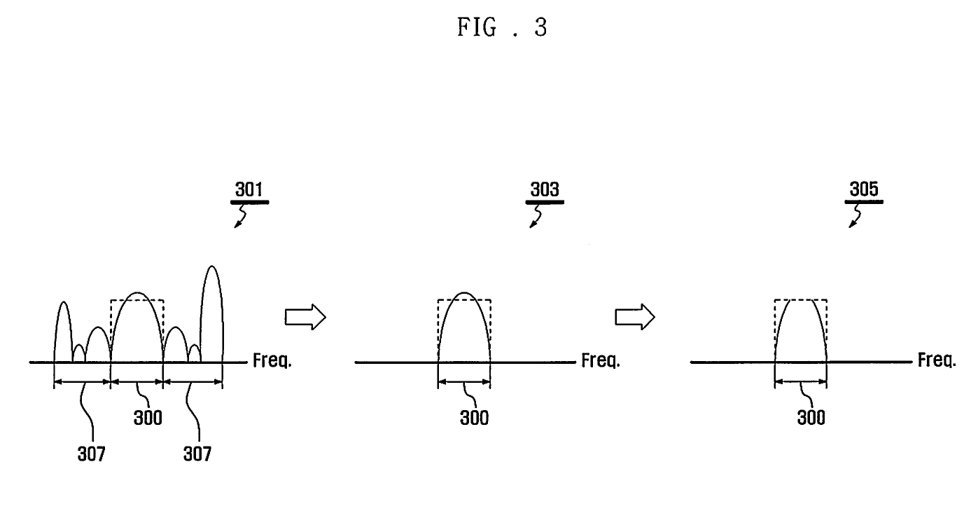

FIG. 3 is a view describing a band-limited input according to an embodiment of the present invention.

Referring to FIG. 3, input signal 301 is input to the band-pass filter. A receiver receives an RF signal transmitted from a transmitter via its antenna. The received RF signal passes through a low noise amplifier (LNA) and is then input to the filtering apparatus. The Q factor is compensated using the power of signals input to and output from the band-pass filter. The reference feedback circuit compares the power of the input signal with that of the output signal and generates a reference signal to adjust the negative resistance −R of the band-pass filter.

However, the signal in an allocated band is input to the filtering apparatus, together with signals in other bands. Input signal 301 includes other signals in various bands actually input to the filtering apparatus. That is, the filtering apparatus receives the signal in an allocated band 300 and interference signals in bands 307 outside the allocated band 300.

In the output signal of the band-pass filter, the power of the signal in allocated band 300 dominates that of the other signals. If the input signal in the allocated band has relatively high power, it is not affected by other signals. On the contrary, if the interference signals in the bands 307 outside the allocated band 300 have higher power than the signal in the allocated band 300, as shown in input signal 301 in FIG. 3, the power of the signal in the allocated band 300 cannot be measured. The reference feedback circuit measures the magnitude of power of input signals in all the frequency bands and the amplitude of the output signal in the allocated band 300.

This means that the sensitivity of the reference feedback circuit is low. If the reference feedback circuit is implemented to have a low sensitivity, it is limited to embody a high Q RF band-pass filter.

Therefore, in an embodiment of the present invention, an input signal in the allocated band is generated to adjust the Q factor of the band-pass filter. There are two methods to generate the input signal in the allocated band 300. First, an input signal 303 is generated by removing interference from the actual input signal 301 and then input to the band-pass filter. Second, an input signal 303 is generated in the allocated band 300 and then input to the band-pass filter.

The reference feedback circuit measures the power of the input signal 303 without interference. The reference feedback circuit measures the magnitude of output power of the filtered signal 305 generated as the input signal 303 without interference passes through the band-pass filter.

If the reference feedback circuit generates a reference signal, a more precise signal can be generated. The filtered signal 305 is generated as the band-pass filter applies the negative resistance −R to the input signal according to the reference signal.

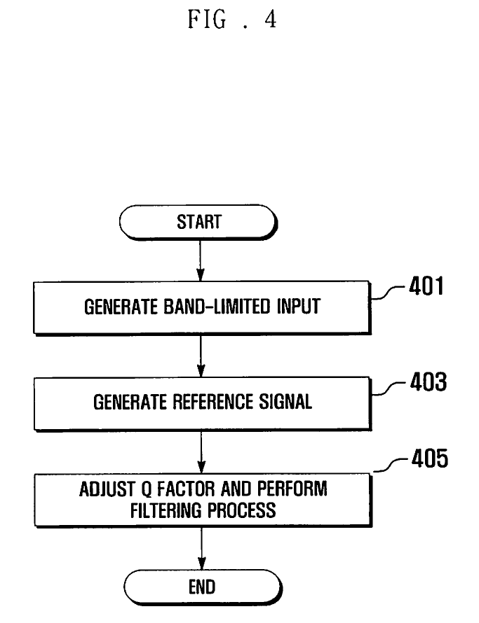

In the following description, a detailed description is provided regarding a filtering method according to an embodiment of the present invention, with reference to FIG. 4. FIG. 4 is a flow chart that describes a filtering method of a receiver according to an embodiment of the present invention.

Referring to FIG. 4, in a wireless communication system, an RF signal received via an antenna is processed by a duplexer and then input to a receiving stage Rx. After that, the signal is processed by the low noise amplifier in the receiving stage Rx and then input to the filtering apparatus.

The filtering apparatus limits the band of the input signal and generates a band-limited input for the system in step 401. To this end, the filtering apparatus may remove signals in the bands other than the allocated band or newly generate a signal in the allocated band of the system bands.

After that, the filtering apparatus compares the power of the input signal in the allocated band with that of the output signal by the allocated band, and generates a reference signal in step 403. That is, the filtering apparatus filters the input signal with respect to the allocated band. During the filtering process, the filtering apparatus measures the power of the input signal in the allocated band and the power of the output signal, and measures the Q factor based on the measured power. After that, the filtering apparatus generates a reference signal for the band-pass filter according to the measured Q factor. The reference signal serves as a feedback signal to adjust the Q factor of the band-pass filter.

Next, the filtering apparatus adjusts the Q factor according to the feedback signal and performs a filtering process for the allocated band in step 405, and then the process ends.

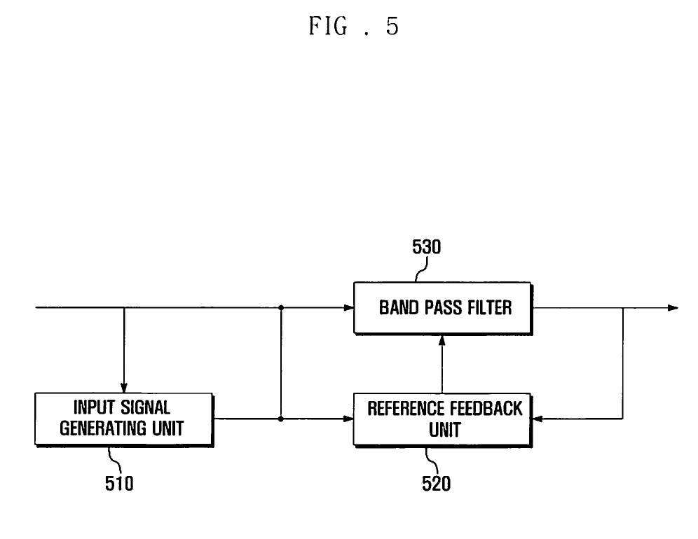

In the following description, a filtering apparatus according to an embodiment of the present invention is explained in detail with reference to FIG. 5. FIG. 5 is a block diagram that describes a filtering apparatus of a receiver according to an embodiment of the present invention.

Referring to FIG. 5, the band-pass filter according to an embodiment of the present invention includes a band-limited input generating unit 510, a reference feedback unit 520, and a band-pass filter 530.

The band-limited input generating unit 510 serves to generate a band-limited input from the input signal. That is, the RF receiver, used in the RF system, removes noise in the bands outside a particular frequency band (the allocated band) that is serving as a system band allocated to the RF receiver, and then generates an input signal in the allocated band. In an embodiment of the present invention, the input signal can be generated as the band-pass filter removes noise in a band outside the allocated band or newly generates a signal in the allocated band of the system bands.

The reference feedback unit 520 adjusts the negative resistance −R of the band-pass filter 530. The reference feedback unit 520 compares the power of the input signal without noise with that of the output signal generated as the band-pass filter filters the input signal with respect to the allocated band. After that, the reference feedback unit 520 identifies the Q factor of the band-pass filter and then performs a feedback process to adjust the Q factor.

The band-pass filter 530 is preferably an RF band-pass filter that passes only a particular band serving as a system band, where the system band is allocated to the RF receiver used in the RF system. In an embodiment of the present invention, the band-pass filter 530 adjusts the negative resistance −R under the control of the reference feedback unit 520 and thus removes parasitic resistance R from the filter, so that it can perform a band-pass filtering process with a high Q factor.

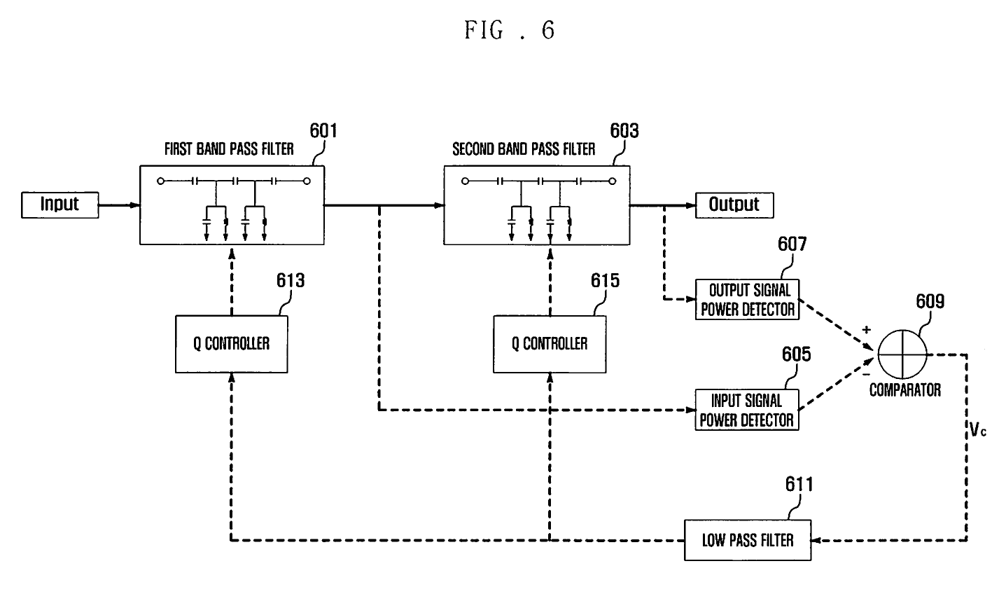

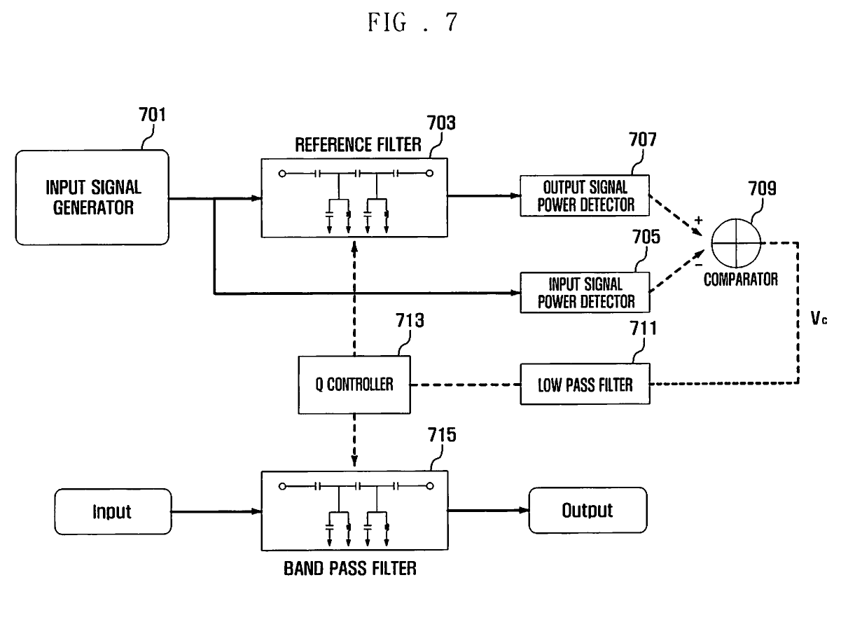

In the following description, the filtering apparatus according to the present invention is explained with preferred embodiments with reference to FIGS. 6 and 7.

FIG. 6 is a block diagram illustrating a filtering apparatus according to an embodiment of the present invention.

Referring to FIG. 6, the filtering apparatus includes a first band-pass filter 601, a second band-pass filter 603, an input signal power detector 605, an output signal power detector 607, a comparator 609, a low pass filter 611, and Q controllers 613 and 615. The Q controllers 613 and 615 are also called negative resistance controllers. In an embodiment of the present invention, the filtering apparatus is configured to perform a feedback process.

Referring to FIGS. 5 and 6, the first band-pass filter 601 serves as the input signal generating unit 510. The input signal power detector 605, the output signal power detector 607, the comparator 609, the low pass filter 611 and the Q controllers 613 and 615 serve as the reference feedback unit 520. The second band-pass filter 603 serves as the band-pass filter 530.

The first band-pass filter 601 filters signals in a band other than the band of the receiver from the received RF signal, and generates a band limited signal. That is, the first band-pass filter 601 generates a signal as shown in input signal 303 from a signal as shown in input signal 301, as shown in FIG. 3.

The second band-pass filter 603 receives the output signal of the first band-pass filter 601. The second band-pass filter 603 performs a filtering process to output a signal in an allocated band. The second band-pass filter 603 performs a filtering process by adjusting negative resistance −R according to a reference signal.

The input and output signal power detectors 605 and 607 detect the power of signals input to and output from the second band-pass filter 603, respectively. The input and output signal power detectors 605 and 607 output voltages corresponding to the detected input and output power, respectively. That is, the input and output signal power detectors 605 and 607 output different levels of voltages between the input and output signals according to the detected power, respectively.

The comparator 609 compares the voltage level of the input signal with that of the output signal, and generates and outputs a reference signal serving as a control voltage Vc.

The low pass filter 611 allows the reference signal to be in a steady state. That is, the low pass filter 611 adjusts the rate of variation of the control voltage Vc and controls the time constant of the entire loop in the filtering apparatus.

The Q controllers 613 and 615 receive the control voltage Vc output from the low pass filter 611. The Q controllers 613 and 615 compensate the negative resistance −R, i.e., a Q factor, of the first and second band-pass filters 601 and 603, respectively.

If the output signal has the same level of power as the input signal in the allocated band, a pass-band response of the filter can be 0 dB, which is the characteristic of an ideal filter. If a difference exists between the power of input and output signals, the reference signal (control voltage Vc) adjusts the negative resistance −R of the first and second band-pass filters 601 and 603, respectively, thereby compensating the Q factors. On the contrary, if the same level of power is detected, the filtering apparatus fixes the reference signal (control voltage Vc) and retains the negative resistance −R of the filter.

The filtering apparatus according to the present invention can stably perform a filtering process with the addition of only one filter. That is, the filtering apparatus can process the input signal through two filters, and thus can better attenuate the interference band other than the allocated band.

FIG. 7 is a block diagram illustrating a filtering apparatus according to another embodiment of the present invention.

Referring to FIG. 7, the filtering apparatus includes an input signal generator 701, a reference filter 703, an input signal power detector 705, an output signal power detector 707, a comparator 709, a low pass filter 711, a Q controller 713, and a band-pass filter 715. The Q controller 713 is also called a negative resistance controller. In an embodiment of the present invention, the filtering apparatus is configured to perform a feedback process.

Referring to FIGS. 5 and 7, the input signal generator 701 serves as the input signal generating unit 510. The reference filter 703, the input signal power detector 705, the output signal power detector 707, the comparator 709, the low pass filter 711, and the Q controller 713 serve as the reference feedback unit 520. The band-pass filter 715 serves as the band-pass filter 530.

The input signal generator 701 generates an input signal in an allocated band and outputs it to the reference filter 703. Unlike the first embodiment of FIG. 6 where the interference of a band other than the allocated band is removed from the actual input signal, the input signal generator 701 generates only an input signal in an allocated band. For example, a system band has 2˜3 GHz, the input signal generator 701 generates an input signal with a band of 2˜3 GHz and then outputs it to the reference filter 703. The input signal in an allocated band can be generated as an oscillator for generating a signal tone performs a frequency sweeping.

The reference filter 703 passes the same band as the band-pass filter 715. The reference filter 703 generates a reference signal to adjust the Q factor according to the actual input signal of the band-pass filter 715. That is, the reference filter 703 serves as a band-pass filter that passes the generated input signal in an allocated band.

The input and output signal power detectors 705 and 707 detect the power of signals input to and output from the reference filter 703, respectively. The input and output signal power detectors 705 and 707 output voltages corresponding to the detected input and output power, respectively. The output voltages of the input and output signals have different levels according to the detected power level.

The comparator 709 compares the voltage level of the input signal with that of the output signal, and generates and outputs a control voltage Vc serving as a reference signal.

The low pass filter 711 allows the output control voltage Vc to be in a steady state.

The Q controller 713 receives the control voltage Vc output from the low pass filter 711. The Q controller 713 compensates the negative resistance −R, i.e., a Q factor, of the reference filter 703 and the band-pass filter 715, respectively.

The band-pass filter 715 performs a filtering process where it compensates the Q factor according to the compensation of the Q controller 713 and generates a signal in the allocated band.

Unlike the first embodiment of FIG. 6, the filtering apparatus according to the second embodiment of FIG. 7 uses the input signal generator 701 and the reference filter 703. That is, the filtering apparatus of FIG. 7 generates an input signal in an allocated band through the input signal generator 701, and then measures the Q factor of the filter, using the input signal in the allocated band and the output signal generated as the reference filter filters the input signal in the allocated band. After that, the filtering apparatus adjusts the negative resistance −R of the band-pass filter using the measured Q factor. Similar to the first embodiment of FIG. 6, the filtering apparatus according to the second embodiment varies the reference signal (control voltage Vc), adjusts the negative resistance −R of the filter, and compensates the Q factor, if a difference exists between the power levels of the input and output signals. On the contrary, if the same level of power is detected, the filtering apparatus fixes the reference signal (control voltage Vc) and retains the negative resistance −R of the filter.

The filtering apparatus according to the second embodiment employs the input and output signal power detectors 705 and 707 that have a relatively narrow measurement range of power. The filtering apparatus can precisely measure the Q factor using the input and output signal power detectors 705 and 707.

As described above, the filtering apparatus and method, according to the present invention, can precisely analyze the relationship between the signals input to and output from a filter in a band of a receiver and thus can implement a band-pass filter having a high Q factor. In addition, the filtering apparatus and method can remove interference of input signals and thus can more precisely control the Q factor, thereby stably operating the circuit.

Although exemplary embodiments of the present invention have been described in detail hereinabove, it should be understood that many variations and modifications of the basic inventive concept herein described, which may be apparent to those skilled in the art, will still fall within the spirit and scope of the exemplary embodiments of the present invention as defined in the appended claims.

What is claimed is:

1. A filtering apparatus using a reference feedback circuit of a receiver in a wireless communication system, the filtering apparatus comprising:
an input signal generating unit for generating an input signal in an allocated band that the receiver uses;
a reference feedback unit for comparing the power of the input signal with that of an output signal generated as a band-pass filter filters the input signal with respect to the allocated band, and for generating a reference signal; and
the band-pass filter for adjusting the quality (Q) factor of a receiver according to the reference signal and for passing frequencies of the input signal input to the receiver only within the allocated band.

2. The filtering apparatus of claim 1, wherein the input signal generating unit comprises:
an input filter for passing frequencies of signals received by the receiver within the allocated band and for outputting the input signal.

3. The filtering apparatus of claim 1, wherein the reference feedback unit comprises:
an input signal power measuring unit for measuring power of the input signal;
an output signal power measuring unit for measuring power of the output signal generated as the band-pass filter filters the input signal within the allocated band;
a comparator for comparing the power of the input signal with that of the output signal and generating a reference signal; and
a controller for outputting a control signal according to the reference signal, where the control signal adjusts the Q factor of the band-pass filter.

4. The filtering apparatus of claim 1, wherein the input signal generating unit comprises:
an input signal generator for generating the input signal having the allocated band and for outputting the input signal.

5. The filtering apparatus of claim 1, wherein the reference feedback unit comprises:
a reference filter for filtering the input signal within an allocated band;
an input signal measuring unit for measuring the power of the input signal input to the reference filter;
an output signal measuring unit for measuring the power of the output signal from the reference filter;
a comparator for comparing the power of the input signal with that of the output signal and for generating a reference signal; and
a controller for outputting a control signal according to the reference signal, where the control signal adjusts the Q factor of the reference filter and the band-pass filter.

6. A filtering method using a reference feedback circuit of a receiver in a wireless communication system, the filtering method comprising:
generating an input signal in an allocated band that the receiver uses;
comparing the power of the input signal with that of an output signal generated as a band-pass filter filters the input signal with respect to the allocated band, and generating a reference signal; and
adjusting the quality (Q) factor of a receiver according to the reference signal and for passing frequencies of the input signal input to the receiver only within the allocated band.

7. The filtering method of claim 6, wherein the input signal in an allocated band is generated as frequencies of signals received by the receiver pass within the allocated band.

8. The filtering method of claim 6, wherein generating a reference signal comprises:
measuring power of the input signal;
measuring power of the output signal generated as the band-pass filter filters the input signal within the allocated band;
comparing the power of the input signal with that of the output signal, and generating the reference signal; and
outputting a control signal according to the reference signal, where the control signal adjusts the Q factor.

9. The filtering method of claim 6, wherein the input signal is generated to have the allocated band.

10. The filtering method of claim 6, wherein generating a reference signal comprises:
measuring power of the input signal;
filtering the input signal within an allocated band;
measuring power of the filtered input signal;
comparing the power of the input signal with that of the filtered input signal, and generating the reference signal; and
outputting a control signal according to the reference signal, where the control signal adjusts the Q factor.
